(19) United States
(12) Patent Application Publication
(10) Pub. No.: US 2006/0115621 A1
(43) Pub. Date: Jun. 1, 2006

(54) Non-sewn adhesive tape and the manufacture thereof

(76) Inventor: Shih-Sheng Yang, Taipei Hsien (TW)

Correspondence Address: LEONG C LEI, PMB # 1008, 1867 YGNACIO VALLEY ROAD, WALNUT CREEK, CA, 94598, US

(21) Appl. No.: 11/332,374

(22) Filed: Jan. 17, 2006

Related U.S. Application Data
(62) Division of application No. 10/832,309, filed on Apr. 27, 2004.

(51) Int. Cl. B32B 3/06

(52) U.S. Cl. 428/100

(57) ABSTRACT

The invention discloses a non-sewn adhesive tape and the manufacture thereof. An upper mold is disposed correspondingly to a lower mold such that a space for injection will form between the upper and lower molds. After injection, one end surface of the space for injection will form pluralities of guide grooves and ribs with through holes at their side edge, while the other end surface will form an adhesive tape with pluralities of cross-directional hooks. The surface of the upper mold block has pluralities of guide grooves and ribs arranged in sequence, while the lower mold block is composed of pluralities of first moldboards with hooks and second moldboards provided with pluralities of recessions and extrusions. By way of one end surface of the adhesive tape where there are pluralities of guide grooves and ribs, the object can be provided with the adhesive tape by injecting a plastic material into the guide grooves and the through holes of the ribs, to accomplish a non-sewn adhesive tape and the manufacture thereof.

This is a divisional application of the co-depending patent application Ser. No. 10/832,309

### BACKGROUND OF THE INVENTION

(a) Technical Field of the Invention

The present invention relates to a non-sewn adhesive tape and the manufacture thereof, particularly to one that can be directly combined to an object without sewing, such that the adhesive tape can form firmly and integrally with the object, to enhance the quality and aesthetic feeling.

(b) Description of the Prior Art

Generally, when providing an adhesive tape to an object, it is necessary to produce an adhesive tape arranged with hooks on the surface, dispose the adhesive tape on a pre-determined position on the object to be provided with the adhesive tape, and sew on the edge of the adhesive tape by thread to fasten it to the object. Although the adhesive tape can be sewn to the object, the stitching will leave a mark on the object, affecting the aesthetic feeling. Besides, after a period of use or pull by force, the sewing thread would easily detach from the object, rendering detachment of the adhesive tape from the object. Therefore, the prior art wherein the adhesive tape is fastened to the object via sewing is not practical in use and cannot be applied satisfactorily in high class clothing articles due to the rough quality.

In addition, the adhesive tape structure of the prior art is full of hook-type felt and will form a prickly surface, which would easily scratch the clothing or prick up the lint of the cloth. Accordingly, there exists a need for improvement of the prior art.

### SUMMARY OF THE INVENTION

The primary object of the invention is to provide an adhesive tape directly to an object without sewing, wherein the hooks of the adhesive tape are free from picking up lint.

Another object of the invention is to provide a firmly combination between the object and the adhesive tape, in order to obtain a high quality and aesthetic feeling.

To obtain the above objects, the invention discloses a non-sewn adhesive tape and the manufacture thereof. An upper mold is disposed correspondingly to a lower mold such that a space for injection will form between the upper and lower molds. After a plastic material is injected into the space for injection, an adhesive tape will be formed. The surface of the upper mold block has pluralities of guide grooves and ribs arranged in sequence, while the lower mold block is composed of pluralities of first moldboards with hooks and second moldboards provided with pluralities of recessions and extrusions. By way of one end surface of the adhesive tape where there are pluralities of guide grooves and ribs, the object can be provided with the adhesive tape by injecting a plastic material into the guide grooves and the through holes of the ribs, to accomplish a non-sewn adhesive tape and the manufacture thereof.

The foregoing object and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the alt upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is an exploded view of the lower mold block according to the present invention.

FIG. 2 is a perspective view of the upper and lower mold blocks according to the present invention.

FIG. 3 is a cut-away view showing the corresponding status of the upper and lower molds.

FIG. 4 shows detachment of the molds.

FIG. 5 shows detachment of the adhesive tape from the lower mold.

FIG. 6 shows the backside of the adhesive tape according to the invention.

FIG. 7 is a partially enlarged view taken from FIG. 6.

FIG. 8 is a cross-sectional view of the adhesive tape according to the invention.

FIG. 9 is a partially enlarged view taken from FIG. 8.

FIG. 10 shows the front side of the adhesive tape according to the invention.

FIG. 11 is a partially enlarged view taken from FIG. 10.

FIG. 12 a cross-sectional view showing the combination of the adhesive tape and the object.

FIG. 13 is a perspective view showing the combination of the adhesive tape and the object.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

The present invention discloses a non-sewn adhesive tape and the manufacture thereof, including the following steps:

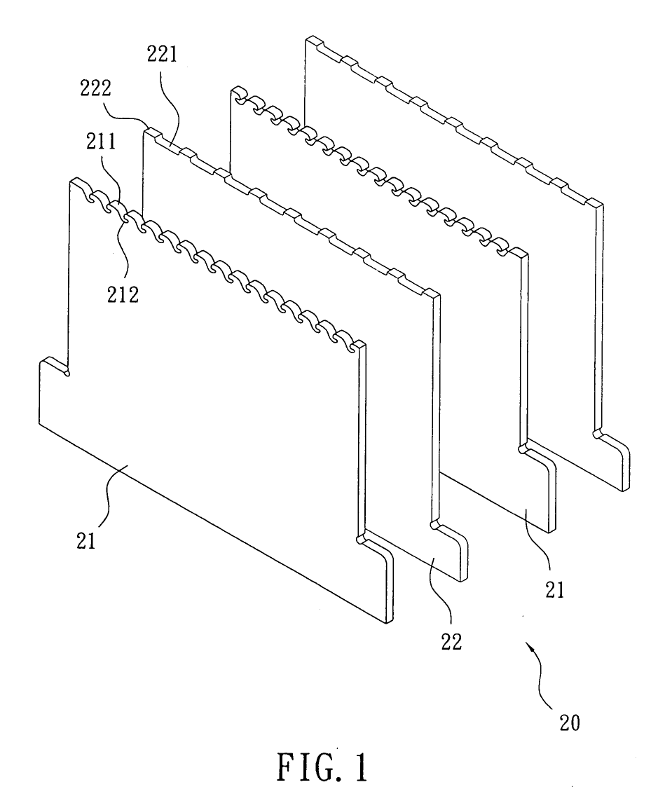

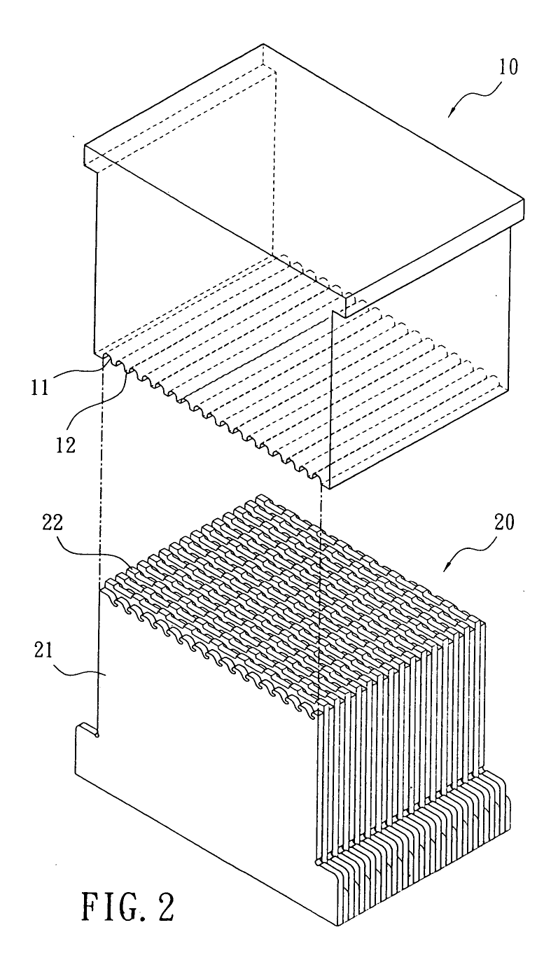

As shown in FIGS. 1 and 2, there are an upper mold 10 and a lower mold 20 (as shown in FIG. 1). The surface of the upper mold 10 has pluralities of recessive guide grooves 11 and extruding ribs 12, while the lower mold 20 is composed of pluralities of first moldboards 21 and second moldboards 22 (as shown in FIG. 1). The end surface of each first moldboard 21 is provided with pluralities of hooks 211 and grooves 212, each of which is provided between every two hooks 211. The end surface of the second moldboards 22 is provided with pluralities of recessions 221 and extrusions 222, between every two of which is provided with one recession 221. The lower mold block 20 is installed in the sequence that the first moldboard 21 is disposed vertically next to the second moldboard 22, such that the level of the arrangement of recessions 221 and the extrusions 222 on the second moldboards 22 would be slightly higher than the top end surface of the hooks 211 on the first moldboards 21, rendering a height difference between the top end surfaces of the first moldboards 21 and the second moldboards 22 (as shown in FIG. 2). As the first moldboards 21 are arranged in sequence in the form that the hooks 211 face front and back, the opening of the grooves 212 on the first moldboards 21 would face front and back, rendering the hooks 211 on the first moldboards 21 being cross-directional at two sides of each second moldboard 22 (with reference to FIG. 11).

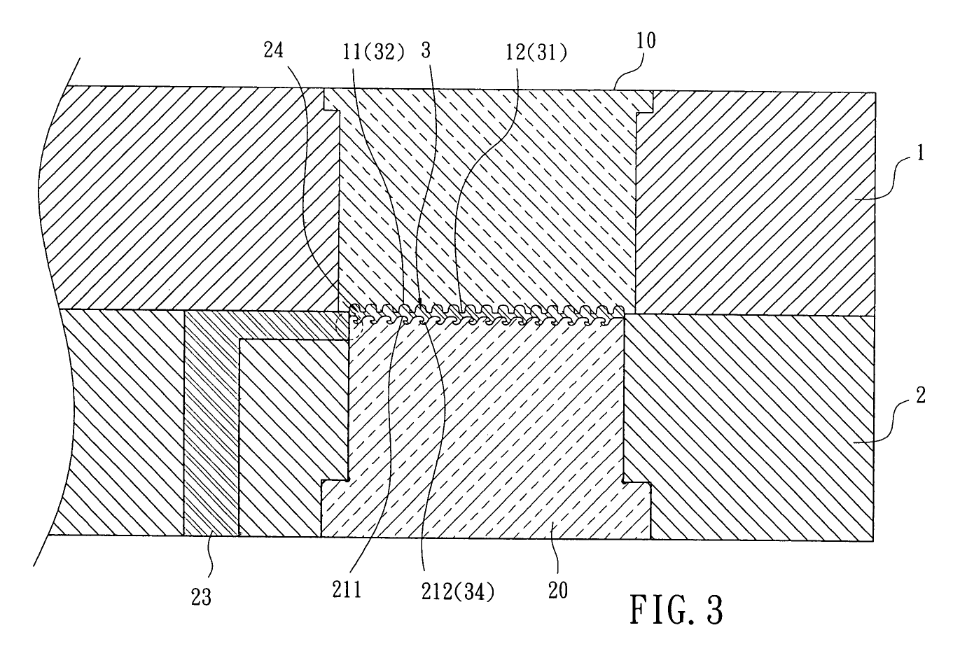

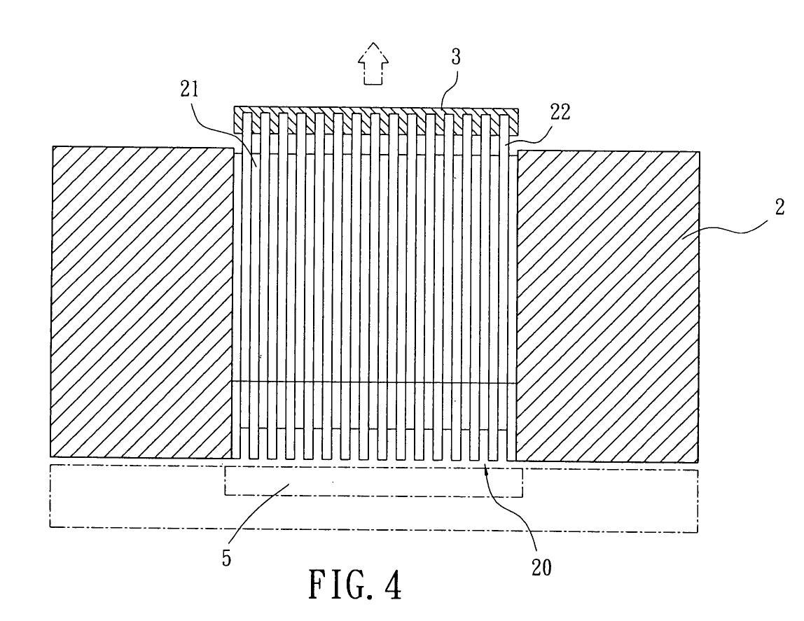

Referring to FIGS. 3 and 4, the upper mold block 10 is disposed on an upper mold 1, while the lower mold block 20 is disposed on a lower mold 2, which is provided with a sprue 23. The upper mold 1 is corresponding to the lower mold 2, such that the end surface of the upper mold block 10 will attach to the end surface of the lower mold block 20, thereby the guide grooves 11 and ribs 12 on the surface of the upper mold block 10 will cross in a vertical way above the hooks 211, grooves 212, recessions 221 and extrusions 222 on each first moldboard 21 and second moldboard 22 of the lower mold block 20 (as shown in FIG. 2), thereby forming a space for injection 24 between the upper and lower mold blocks 10, 20, and allowing the sprue 23 of the lower mold 2 at a position corresponding to the space for injection 24.

When injecting a plastic material into the space for injection 24, the plastic material will flow in between each guide groove 11 & rib 12 on the surface of the upper mold block 10 and the hooks 211, grooves 212, recessions 221 & extrusions 222 on the end surface of the first and second moldboards 21, 22, thereby forming an adhesive tape 3 (as shown in FIG. 3).

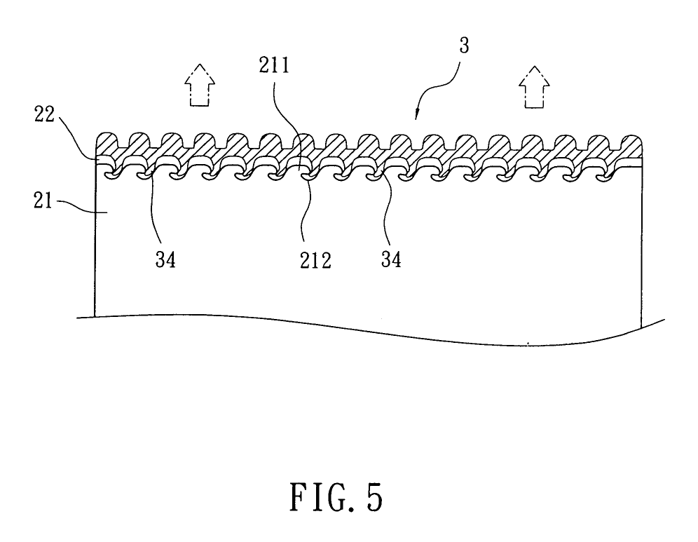

Now referring to FIGS. 4 and 5, FIG. 4 shows a cut-away view of the lower mold 2, the bottom end of which is provided with a pressure device 5. When detaching the upper mold 1 from the lower mold 2, the thin adhesive tape 3 will naturally be held on the surface of the first moldboards of the lower mold 2. As hooks 23 are formed in the grooves 212, the adhesive tape 3 being in a high temperature cannot be pulled out at this moment. To enable the adhesive tape 3 be detached from the mold smoothly, the pressure device 5 can be used to bump against the lower end of the second moldboards 22 and make them be in an extrusive status. As the second moldboards 22 are provided with extrusions 22 having leveled ends, the adhesive tape 3 can be propped up thereby (as shown in FIG. 4), thereby detaching the hooks 34 (felt filaments) of the adhesive tape 3 from each groove 212.

FIG. 5 shows that the adhesive tape 3 is detached from the lower mold 2 due to the extrusive status of the second moldboards 22. The hooks 34 thus can be pulled out of each groove 212 on the first moldboard 21, to form a thin patch of adhesive tape 3.

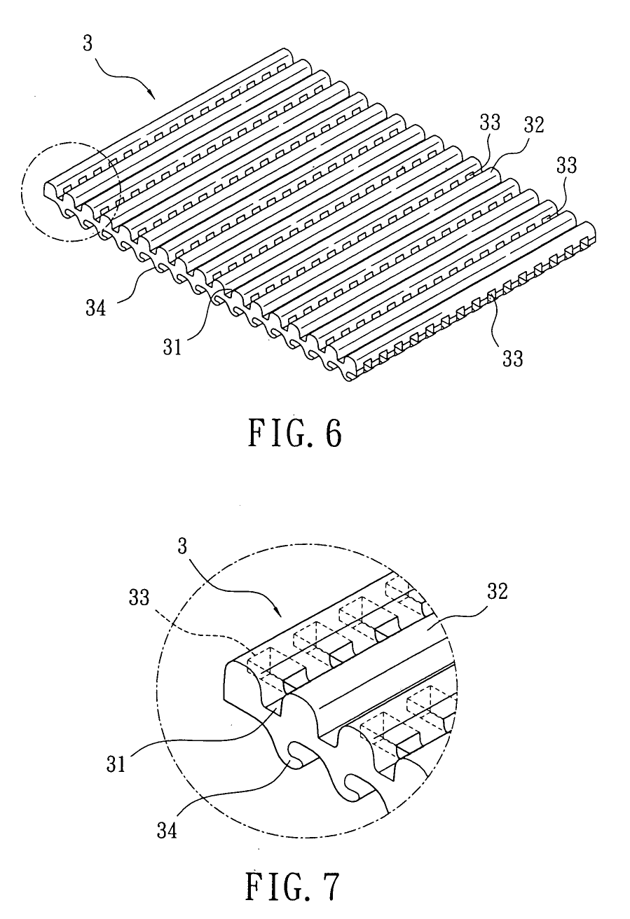

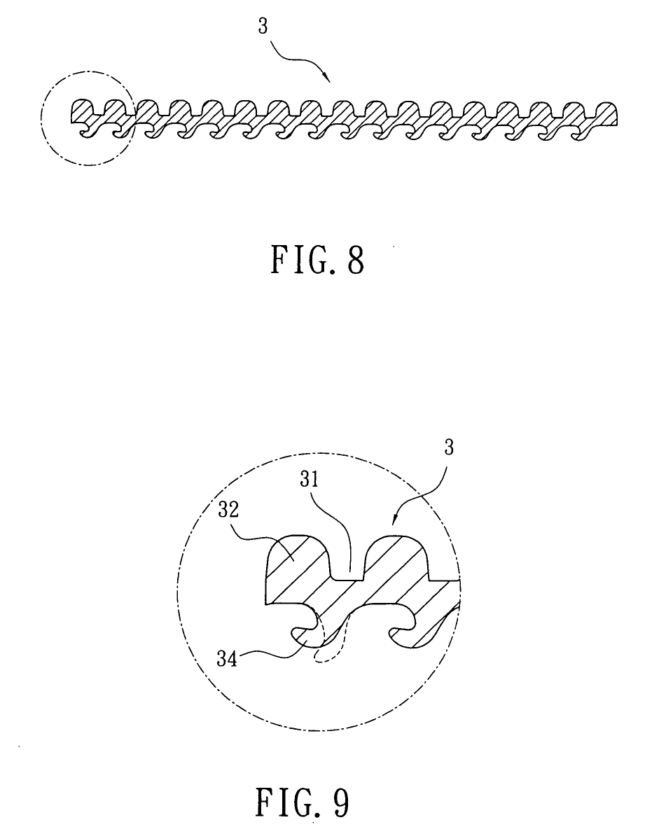

Referring to FIGS. 6 to 9, the produced adhesive tape 3 has pluralities of guide grooves 31 and ribs 32 arranged in sequence at one side. There are pluralities of through holes 33 (as shown in FIG. 7) provided at the side edge of specific ribs 33. And another end surface of the adhesive tape 3 has pluralities of hooks 34, which are in different direction from each other (as shown in FIGS. 7 and 9).

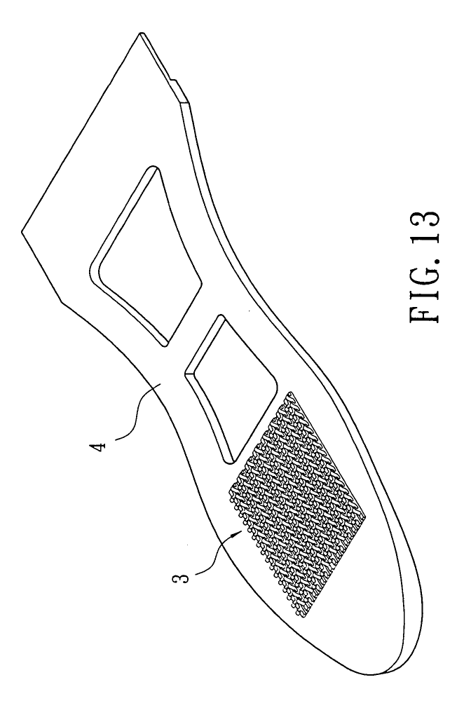

As shown in FIGS. 9 and 13, the top of the hooks 34 on the adhesive tape 3 made according to the present invention appears an arc shape, so as to prevent the risk of picking up the threads of the object.

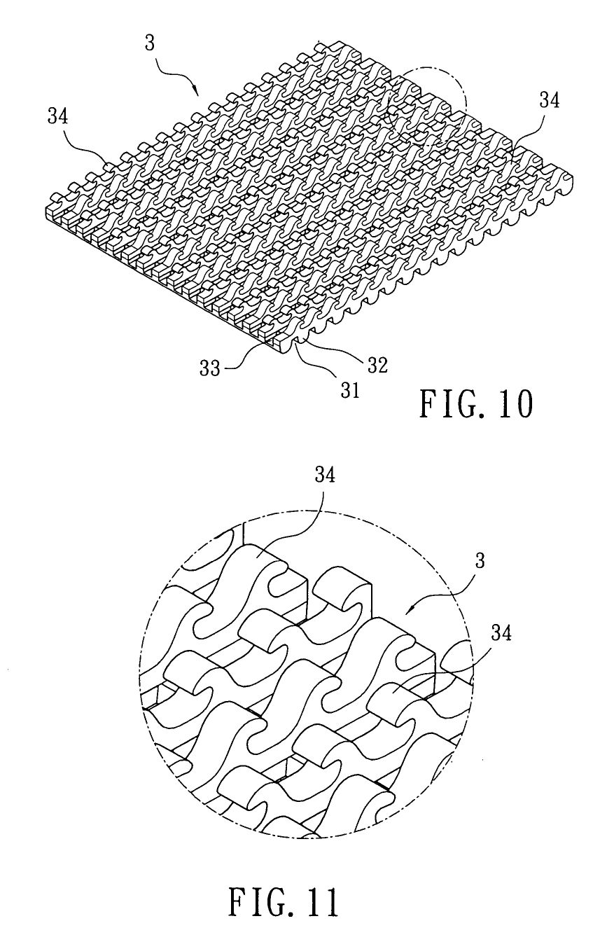

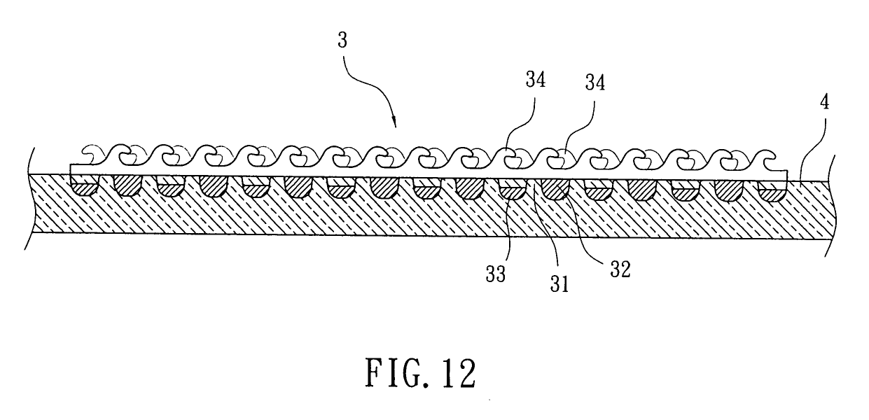

Referring to FIGS. 10 to 13, the adhesive tape 3 can be integrally combined to an object 4 via plastic injection, i.e. disposing the adhesive tape 3 in another mold (not shown), injecting a plastic material into the end surface having pluralities of guide grooves 31 and ribs 32 with through holes 33 at the side edge. When the plastic material is injected into the guide grooves 31 and the through holes 33 around the ribs 32 for combining the object 4 (as shown in FIGS. 12 and 13), the adhesive tape 3 and object 4 will integrally combined together via the guide grooves 31 and the through holes 33 at the ribs 32. Accordingly, a non-sewn adhesive tape 3 can be installed to the object 4 (as shown in FIG. 13). The adhesive tape 3 made according to the present invention is applicable to high class clothing, to enhance the quality and aesthetic feeling of the clothing articles.

Concluded above, the non-sewn adhesive tape and the manufacture thereof can allow the adhesive tape 3 be provided at an object 4 via the end surface of the adhesive tape 3 where there are pluralities of guide grooves 31 and ribs 32 and by way of injecting a plastic material into the guide grooves 31 and the through holes 33 of the ribs 32, to directly provide the adhesive tape 3 to the object 4 without the need of sewing process. Accordingly, the object 4 and the adhesive tape 3 can be firmly combined together to obtain an aesthetic effect.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A non-sewn adhesive tape, one end surface of which has pluralities of guide grooves and ribs arranged in sequence, while there are more than one through holes at the side edges of the ribs; another end surface of the adhesive tape has pluralities of cross-directional hooks; accordingly, by way of one end surface of the adhesive tape where there are the pluralities of guide grooves and ribs, the adhesive tape can be integrally formed on the object via injecting the plastic material into the guide grooves and the through holes at the ribs, to accomplish a non-sewn adhesive tape.
